(19) United States
(12) Patent Application Publication
(10) Pub. No.: US 2015/0158443 A1
(43) Pub. Date: Jun. 11, 2015

(54) Vehicle Having Impact Protection

(71) Applicant: Bayerische Motoren Werke Aktiengesellscharft, Muenchen (DE)

(72) Inventors: Wolfgang HAHN, Petershausen (DE); Timm FREUDENBERG, Darmstadt (DE)

(21) Appl. No.: 14/625,058

(22) Filed: Feb. 18, 2015

Related U.S. Application Data
(63) Continuation of application No. PCT/EP2013/065835, filed on Jul. 26, 2013.

(30) Foreign Application Priority Data
Aug. 20, 2012 (DE) 10 2012 214 751.9

(51) Int. Cl. B60R 19/34

(52) U.S. Cl. CPC B60R 19/34

(57) ABSTRACT

A vehicle has a first hollow element made of a composite fiber material, a second element, which is longitudinally displaceable in the hollow element and at least one third element, which is guided through a pertaining hole of a wall of the first element. The at least one third element is arranged in a path of the second element and has a higher stability than the first element.

### CROSS REFERENCE TO RELATED APPLICATIONS

This application is a continuation of PCT International Application No. PCT/EP2013/065835, filed Jul. 26, 2013, which claims priority under 35 U.S.C. §119 from German Patent Application No. 10 2012 214 751.9, filed Aug. 20, 2012, the entire disclosures of which are herein expressly incorporated by reference.

### BACKGROUND AND SUMMARY OF THE INVENTION

The invention relates to a vehicle, particularly a passenger car, having a first hollow element made of a composite fiber material, such as an engine mount, and a second element, which is longitudinally displaceable in the hollow body, such as a so-called crashbox.

For impact or crash structures made of carbon-fiber-reinforced plastic (CFRP) in passenger cars, preferably tube-shaped mounts having a prismatic (for example, rectangular) or round profile are currently used, into which a so-called crashbox is fitted. At its other end, the crashbox is connected with a bumper. In the event of a frontal impact, first the bumper and then the crashbox are used as energy absorbers. When its energy absorption capacity is exhausted and the kinetic energy is not yet completely reduced, the deformed/destroyed bumper or crashbox will impact on the engine mount. As a result, a breakdown will start at the engine mount. If the mount consists of CFRP, the breakdown will follow the so-called “crushing”. In the case of the “crushing” breakdown mechanism, the complete disintegration (pulverization) of the mount primarily takes place as a brittle fracture. An additional form of crushing is the defined deflection of the CFRP material by 180° directly at the impact surface. In this case, the reduction of the kinetic energy is the result of the effect of a fiber failure mechanism in connection with friction. These breakdown mechanisms operate effectively in the event of a frontal impact, during which the force upon the mount is perpendicular with respect to a mount cross-section. Under the influence of transverse forces, where fractions of force occur, which differ from the direction of the surface normal of the cross-sectional area of the mount, structures which are designed for these breakdown mechanisms, will fail in a largely uncontrolled and catastrophic fashion, for example, by buckling.

It is an object of the present invention to at least partially overcome the disadvantages of this prior art and particularly to provide improved impact protection for occupants of vehicles, particularly of passenger cars.

This and other objects are achieved by a vehicle, having a first hollow element made of fiber-reinforced material, a second element longitudinally displaceable in the hollow element and at least one third element, which is guided through a pertaining hole of a wall of the first element. The at least one third element is arranged in a path of the second element and has a higher stability, particularly breaking strength, than the first element.

This construction has the advantage that, when the second element is pushed into the first element, for example, in the case of a frontal impact, the second elements strikes against the at least one third element and takes it along. Since the third element has a higher breaking strength than the first element, it will not be destroyed in the process but will tear open the wall of the first element, whereby a large amount of energy is absorbed. There is the additional advantage that a location of the introduction of force can easily be defined by the position of the hole and of the third element. A force transmission from the third element to the first element can also easily be adjusted quantitatively, for example, by way of a size, shape and position of the third element or of the pertaining hole, as well as by way of the number of third elements. Furthermore, it will now also be conceivable during a lateral or non-frontal impact to direct the force at least considerably in the longitudinal direction of the first element, so that a large amount of energy can then also still be absorbed. A decoupling of the failure mode from the angle of application of the exterior force can therefore be achieved in the event of an impact. The dimensioning of the transverse force is therefore to a very large extent decoupled from the dimensioning of the axial force.

In particular, the first to third elements may represent at least one part of a crash structure of the vehicle.

The first element may particularly represent a slide bearing for the second element.

In a (normal) starting condition, thus, not in the event of an impact, the second element may be arranged completely outside the first element or may be partially fitted into the first element.

The type of composite fiber material is basically not limited and may particularly have carbon-reinforced or fiber-glass-reinforced plastic or consist of the latter.

The third element may be fastened in the pertaining hole without any pressure on the face of the hole or with virtually negligible pressure, so that, in the event of an impact, a force exercised by the second element is transmitted directly to the first element. As an alternative, the third element may be fastened in the pertaining hole with a specified not negligible pressure on the face of the hole.

In both cases, the pertaining failure mode may be considered to be a failure with respect to the inside of the hole, which is initiated by the third element that is pulled by the first element.

The path of the second element may particularly be understood to be its path in the first element in the case of an impact. The path may also be called a track, route or the like. The path may particularly represent a linear path in the moving direction of the second element.

It is a further development that at least one third element (at least in the area of the wall of the first element) has a round cross-section. Because of the round shape, the failure mode or the energy reduction is independent of a force application angle; the third element is always pulled through the laminate for the energy absorption. In this case, a structure of the composite material is advantageous that is quasi isotropic at least in the moving direction.

Particularly in the case of a round cross-section, there is a relationship with respect to the force level F exercised by the third element, which force level F is proportional to a diameter D (at least in the area of the wall of the first element) of the third element, thus F˜D. Analytically, a maximal force level Fu can be expressed as Fu=RL*D*t with RL being a maximally achievable bearing strength, D being the diameter and t a wall thickness of the wall of the first element.

However, the cross-sectional shape of the third element is not restricted to a round shape and may, for example, also be oval, elliptical, polygonal, concave, convex, free-formed, etc.

It is another further development that at least one third element is designed as a bolt inserted from the outside into the wall of the first element. This bolt can be easily mounted and reliably utilized. A bolt with a round cross-section is particularly preferred. In particular, the bolt may also be further developed as a screw.

It is an alternative or additional further development that at least one third element includes a rod guided by the first element. At two positions, the rod extends through the wall and has the advantage that it permits a high energy absorption at low mounting expenditures.

It is a further development that the first element has several third elements, which are arranged side-by-side or offset with respect to the path of the second element. As a result, the wall can be torn open at several points parallel to the moving direction of the second element or to the longitudinal direction of the first element, which results in a particularly high energy transfer. The second elements can be arranged at the same position or depth at the first element and/or offset in the moving direction, which permits a graduated force transmission.

It is another further development that the at least one third element is designed in the form of several adjacent third elements, and a ratio (“W/D ratio”) between a distance W of adjacent holes to a cross-sectional width of the pertaining third elements (for example, the diameter D) amounts to at least five (5). It is thereby ensured that the third elements are not situated so close to one another that, in the event of an impact, they excessively weaken the wall strips situated between them or even fail early, before entering the inside of the hole.

It is an additional further development that the first element is a hollow prismatic element (with a cornered cross-section). This prevents a rotating movement of the second element in the first element. However, as an alternative, the first element may have any desired cross-sectional shape, such as a circular shape.

In addition, it is a further development that a ratio (“E/D ratio”) between a distance E of a hole from an edge of the first element to its cross-sectional width amounts to at least three (3). As a result, a reduced energy absorption by the first mount in the area of an edge as well as a deformation of the edge can be prevented. In particular, an edge is the edge extending in the longitudinal direction of the first mount. An edge particularly corresponds to a corner of a cross-section of the first element.

It is an additional further development that the vehicle has several third elements which are arranged on different wall sections of the first element. As a result, a particularly high energy absorption can be achieved. A wall section, in particular, is an area that can be limited in the circumferential direction. The limiting may, for example, take place by means of an edge. In particular, a wall section may be an area between two corners that is in a straight line in its cross-section. In the case of a first element that is rectangular in its cross-section, for example, a top side, a bottom side, a right side and a left side of the first element may represent different wall sections with possibly different characteristics, particularly strengths.

In addition, it is a further development that at least one hole has a larger width than a third element extending through it and a correspondingly fitting insertion element is placed in the hole, by which insertion element the third element is guided in a fitting manner or with a slight play. This results in the advantage that, by using the “modular principle”, a third element with a first width (for example, a first diameter) can be used for a first specified force level, and higher force levels are generated by the insertion element. In this manner, a scaling of the force level can be carried out while the component geometry (profile cross-section and wall thickness) is constant. Furthermore, the force level can be lowered by a suitable selection of an exterior width, particularly of an outside diameter, of the insertion element by lowering the W/D ratio.

It is a further development that the insertion element has an interior hole, which may have a shape and size (for example, diameter) corresponding to the third element, particularly for the precisely fitting insertion of the third element. An exterior-side shape and size (for example, diameter) of the insertion element may correspond to a shape and size of the hole, particularly for the precisely fitting insertion of the insertion element into the hole of the first element. A W/D (distance/diameter) ratio may then particularly apply to the interior hole.

It is also a further development that the second element is a connection element connected with a bumper. The second element may particularly be a crashbox.

It is also a further development that the first element is an engine mount.

A crash structure may particularly have a (forward or rearward) bumper, at least two second elements mounted on the latter, and respective third elements.

The above-mentioned first to third elements or a crash structure having these elements may represent part of a forward vehicle body or of a rearward vehicle body. The crash structure may also be used for absorbing a lateral impact.

Other objects, advantages and novel features of the present invention will become apparent from the following detailed description of one or more preferred embodiments when considered in conjunction with the accompanying drawings.

### BRIEF DESCRIPTION OF THE DRAWINGS

For reasons of clarity, the same elements or elements having the same effect will be provided with identical reference symbols.

FIG. 1 is a top view of an outline of a forward vehicle body with a pertaining crash structure having first and second elements;

FIG. 2 is a front view of a first element with several third elements according to a first embodiment;

FIG. 3 is a sectional representation as a lateral view of a wall of a first element having a third element guided in the latter in a normal condition;

FIG. 4 is a top view from the outside of the wall of FIG. 4 with the first element in the case of an impact;

FIG. 5 is a front view of a first element with several third elements according to a second embodiment;

FIG. 6 is a perspective view of the first element with several third elements inserted therein in a normal condition;

FIG. 7 is a perspective view of the first element from FIG. 6 in the case of an impact; and

FIG. 8 is a sectional view of a wall of the first element with a third element inserted in a hole thereof, and additionally of an insertion element.

### DETAILED DESCRIPTION OF THE DRAWINGS

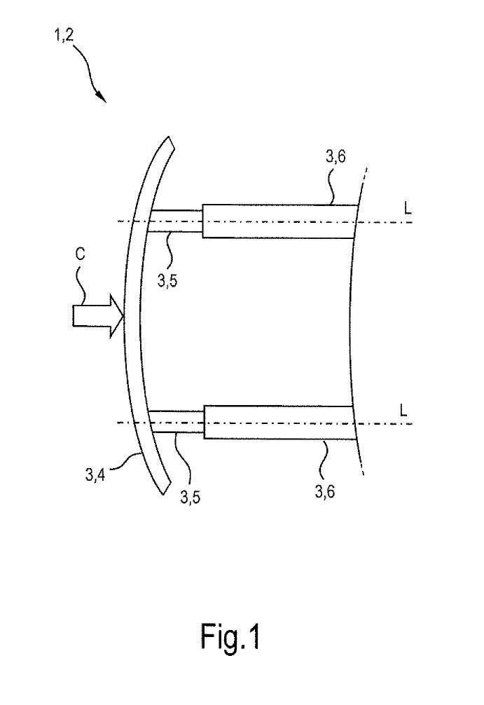

FIG. 1 is a top view of an outline of a forward vehicle body 1 of a passenger car 2 with a pertaining crash structure 3. The crash structure 3 has a forward bumper 4, which is fastened to two second elements in the form of crashboxes 5. In the illustrated normal condition, the crashboxes 5 are partially inserted in first elements in the form of engine mounts 6. The engine mounts 6 are constructed as tube-shaped hollow profiles made of CFC having a rectangular cross-sectional shape. The crashboxes also have a basic rectangular shape and are longitudinally displaceably arranged in the engine mounts 6.

In the event of a frontal impact at a high speed, which is indicated by the arrow C, the bumper 4 with the crashboxes 5 will be displaced such that the latter impact the engine mounts 6 and destroy the mounts while delivering energy. Because the engine mounts 6 consist of CFC, energy will not be absorbed by plastic deformation, but rather the engine mounts 6 will be destroyed by complete disintegration (pulverization) and/or deflection of the CFC material. Under the influence of transverse forces, as they occur, for example, in the case of a lateral impact, however, previous engine mounts will fail in a largely uncontrolled and catastrophic manner, for example, by buckling, while absorbing noticeably less energy.

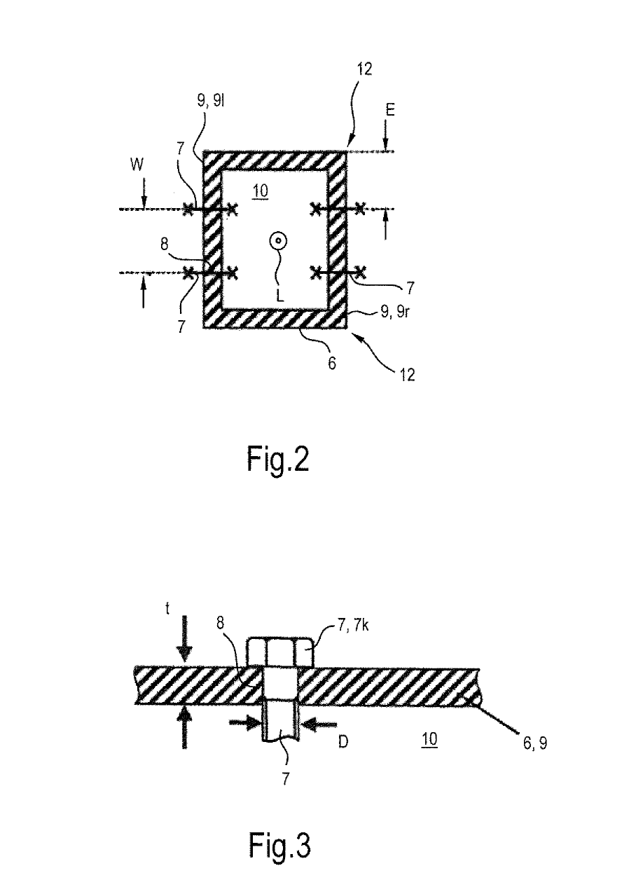

FIG. 2 is a front view of an engine mount 6 with four third elements in the form of bolts 7. The bolts (for example, bolt in the narrower sense includes screws, rivets, pins, etc.) were inserted from the outside through respectively pertaining fitting holes 8 into a wall 9 and thereby guided through the hole 8. The bolts 7 consist, for example, of metal, such as steel, and therefore have a higher stability, particularly, breaking strength, than the engine mount 6. The bolts 7 have a round cross-section here with a constant diameter D (see also FIG. 3).

More precisely, two bolts 7 are mirror-symmetrically arranged at different opposite wall sections, which correspond to a left side wall 9l (left side) and to a right side wall 9r (right side) of the wall 9. In this case, the bolts 7 are arranged side-by-side with respect to the path of the crashbox and therefore also with respect to a longitudinal direction L of the engine mount 6. In the case of an arrangement at the side walls 9l and 9r, the side-by-side arrangement is an arrangement above one another. The side-by-side arrangement corresponds to an identical position on a longitudinal axis L (see also FIG. 1).

FIG. 3 illustrates the inserted bolt in greater detail. Starting from a head 7k of the bolt 7 resting on the outside against the wall 9 of the engine mount 7, the bolt 7 extends through the wall 9 with its wall thickness t into a hollow interior 10 of the engine mount 6. The bolts 7 therefore project into the interior 10 and, in the case of an impact, are therefore situated in a path of the pertaining crashbox 5. The bolts 7 are particularly fastened to the wall 9 under a specified pressure on the face of the hole. The bolts 7 have a constant diameter D.

A W/D ratio between a distance W between adjacent holes 8, particularly their centers, and the diameter D of the bolts 7 amounts to at least five (see also FIG. 2). The distance W is therefore at least five times as large as the diameter D. As a result, it is prevented that, in the event of an impact, the bolts 7 decisively weaken the bearing cross-section of the engine mount 6.

As illustrated again in FIG. 2, the engine mount 6 has four edges 12 which, in the cross-section, correspond to the corners of the outer contour. Preferably, an E/D ratio between a distance E of a hole 8 from an edge 12 of the engine mount 6 to a diameter D amounts to at least three.

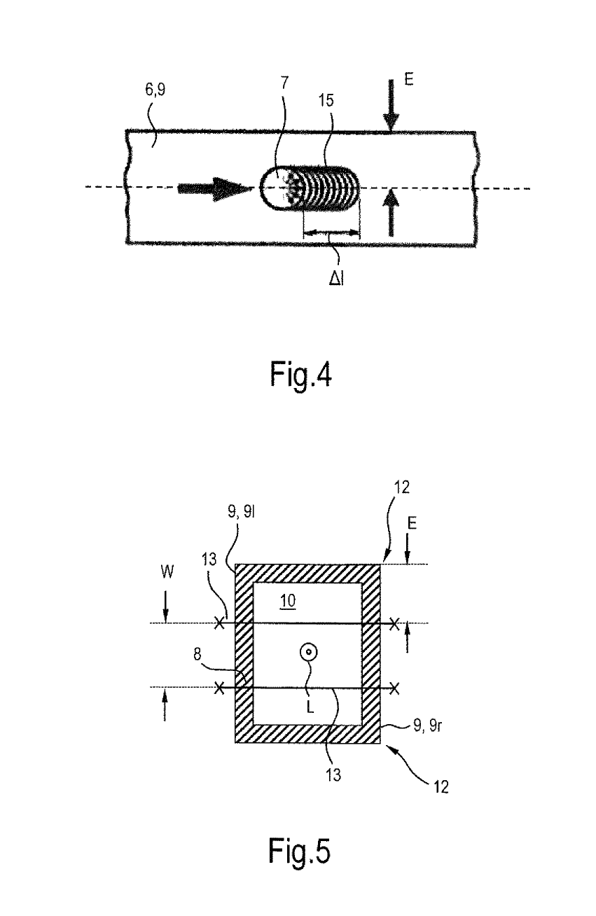

FIG. 4 illustrates a movement of a bolt 7 when the latter is displaced toward the rear by the crashbox 5 by a path Δl, as indicated by the arrow. In this case, the bolt 7, which has higher strengths than the engine mount 6, tears open the wall 9 behind it while energy is being absorbed.

FIG. 5 illustrates the engine mount 6, in which, however, no bolts bu, alternatively or additionally, rods 13 are inserted in a continuous manner.

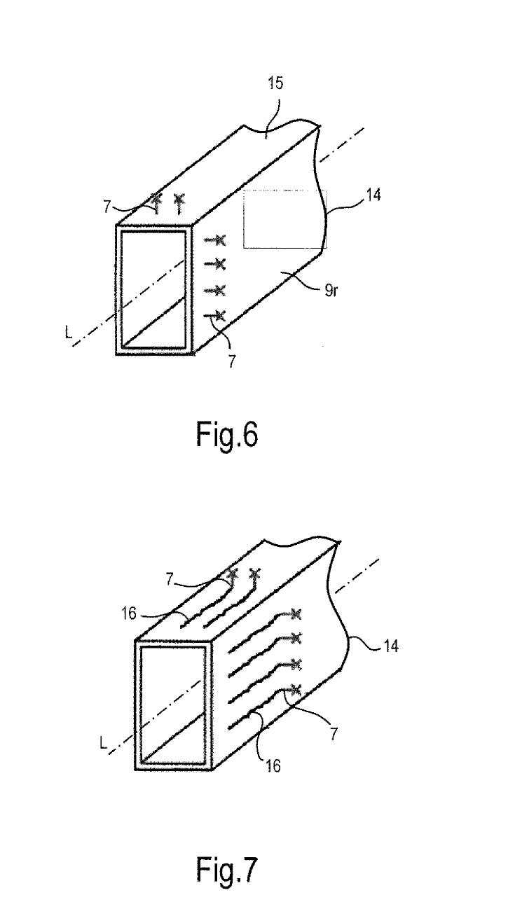

FIG. 6 is a perspective view of an engine mount 14 in a normal condition, in which four bolts 7 are introduced in a side wall 9r above one another and two bolts 7 are introduced side-by-side in an upper wall section 15 (“top side”). The respectively opposite walls or wall sections may also contain bolts, particularly in a mirror-symmetrical manner, which is not shown here. In addition, it is contemplated to provide a second row of bolts 7, which are arranged offset with respect to the first row. This row is also not shown here.

With respect to the longitudinal axis L of the engine mount 14, the illustrated bolts 7 are situated in the same position. The not illustrated crashbox 5 is inserted into the illustrated forward opening of the engine mount 14, specifically maximally to a stop at the bolt.

FIG. 7 is a perspective view of the engine mount 14 in the case of an impact. The crashbox 5 (not shown in FIG. 7) has now displaced the bolts 7 toward the rear, the latter forming tracks 16 of tears in the wall 9 behind them, for whose formation energy is consumed.

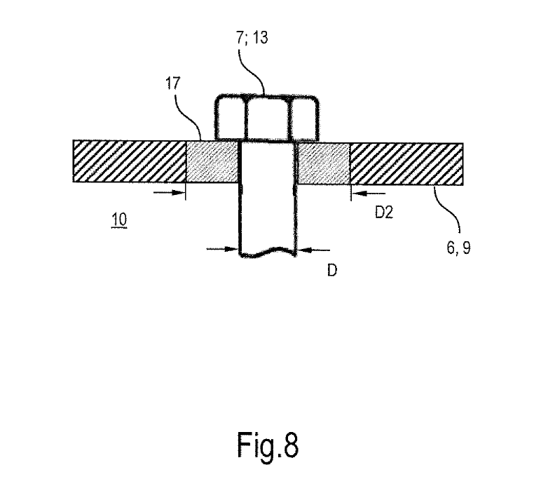

FIG. 8 is a sectional view of a wall 9 of the engine mount 6 having a bolt 7 or rod 13 inserted in its hole 8, and additionally having an insertion element 17. Thus, a bolt 7 etc. can also be inserted without play which has a diameter D that is smaller than a diameter D2 of the hole 8. The insertion element 17 has a tube-shaped design and an outside diameter corresponding to the diameter D2 of the hole 8 and an inside diameter corresponding to the diameter D.

Although the invention was illustrated and described in detail by means of the shown embodiments, the invention is not restricted thereto, and other variations can be derived therefrom by a person skilled in the art without leaving the scope of protection of the invention.

### LIST OF REFERENCE SYMBOLS

1 Forward vehicle body
2 Passenger car
3 Crash structure
4 Bumper
5 Crashbox
6 Engine mount
7 Bolt
7k Adjoining head
8 Hole
9 Wall
9l Left side wall
9r Right side wall
10 Interior
12 Edge
13 Rod
14 Engine mount
15 Upper wall section
16 Trace of tearing
17 Insertion element
C Arrow
D Diameter
Δl Route
E Distance
L Longitudinal direction
t Wall thickness
W Distance

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle, comprising:
a first hollow element made of a composite fiber material;
a second element, which is longitudinally displaceable in the hollow element; and
at least one third element, which is guided through a pertaining hole of a wall of the first element,
wherein the at least one third element is arranged in a path of the second element and has a higher stability than the first element.

2. The vehicle according to claim 1, wherein the at least one third element has a round cross-section.

3. The vehicle according to claim 2, wherein the at least one third element is constructed as a bolt inserted from the outside into the wall of the first element.

4. The vehicle according to claim 1, wherein the at least one third element is constructed as a bolt inserted from the outside into the wall of the first element.

5. The vehicle according claim 1, wherein the at the least one third element is constructed as a rod guided by the first element.

6. The vehicle according claim 2, wherein the at the least one third element is constructed as a rod guided by the first element.

7. The vehicle according to claim 1, wherein several third elements are arranged side-by-side with respect to a path of the second element, and are offset with respect to one another.

8. The vehicle according to claim 1, wherein several adjacent third elements are provided, and a W/D ratio between a distance W of adjacent holes to a cross-sectional width D of the pertaining third elements amounts to at least five.

9. The vehicle according to claim 1, wherein the first element is a hollow-cylindrical element with a cornered cross-section.

10. The vehicle according to claim 9, wherein an E/D ratio between a distance E of a hole from a corner of the first element to its cross-sectional width D amounts to at least three.

11. The vehicle according to claim 1, wherein several third elements are arranged on different wall sections of the first element.

12. The vehicle according to claim 1, wherein
at least one pertaining hole has a larger width than a third element guided through it, and
an insertion element is inserted and fitted into the hole, by which insertion element the third element is fittingly guided.

13. The vehicle according to claim 1, wherein the second element is a connection element.

14. The vehicle according to claim 13, wherein the connection element is a crashbox, connected with a bumper.

15. The vehicle according claim 13, wherein the first element is an engine mount.

16. The vehicle according claim 1, wherein the first element is an engine mount.
